(19) United States
(12) Patent Application Publication
(10) Pub. No.: US 2006/0020104 A1
(43) Pub. Date: Jan. 26, 2006

(54) Preparation of polyphosonates via transesterification without a catalyst

(76) Inventor: Dieter Freitag, Chelmsford, MA (US)

Correspondence Address: Pepper Hamilton LLP;One Mellon Center, 50th Floor, 500 Grant Street, Pittsburgh, PA, 15219, US

(21) Appl. No.: 11/143,230

(22) Filed: Jun. 2, 2005

Related U.S. Application Data
(60) Provisional application No. 60/577,099, filed on Jun. 4, 2004.

(51) Int. Cl. C08G 79/02

(52) U.S. Cl. 528/398

(57) ABSTRACT

Disclosed are embodiments of polyphosphonates produced via a transesterification process that does not required the use of a catalyst, and methods related thereto. Due to the elimination of the catalyst, these polyphosphonates exhibit a unique and advantageous combination of properties, such as fire resistance, improved heat stability, toughness and processing characteristics. Also disclosed are polymer compositions that comprise these polyphosphonates and at least one other polymer, wherein the resulting polymer compositions exhibit flame retardant properties. Further disclosed are articles of manufacture produced from these polymers, such as fibers, films, coated substrates, moldings, foams, fiber-reinforced articles, or any combination thereof.

### CROSS REFERENCE TO RELATED APPLICATIONS

This application claims the benefit of and priority to U.S. Provisional Application Ser. No. 60/577,099 filed Jun. 4, 2004 the contents of which are incorporated herein by reference in their entirety.

### BACKGROUND

Polyphosphonates are known to exhibit excellent fire resistance (see e.g., U.S. Pat. Nos. 2,682,522 and 4,331,614). It is known (see e.g., U.S. Pat. No. 2,682,522) that linear polyphosphonates can be produced by melt condensing a phosphonic acid diaryl ester and a bisphenol using a metal catalyst (e.g., sodium phenolate) at high temperature. Another synthetic approach to produce branched polyphosphonates involves the transesterification reaction of a phosphonic acid diaryl ester, a bisphenol, a branching agent (tri or tetra phenol or phosphonic acid ester), and a preferred catalyst (e.g., sodium phenolate) carried out in the melt, usually in an autoclave. Several patents have addressed the use of branching agents in polyphosphonates (see e.g., U.S. Pat. Nos. 2,716,101; 3,326,852; 4,328,174; 4,331,614; 4,374,971; 4,415,719; 5,216,113; 5,334,692; and 4,374,971). In some cases, the catalyst in the melt is neutralized by adding base binding substances towards the end of the reaction. Neutralization products that are volatile may be removed by distillation, the non-volatile neutralization products remain in the polyphosphonate.

Polyphosphonates have been made in solvent containing processes with halide containing reactants. These require solvent removal or precipitation steps to separate the polyphosphonate from the solvent, and the presence of halide degradation or reactant products can lead to degradation or instability of the polyphosphonate at high temperatures and/or in humid environments.

The preparation of linear and branched polyphosphonates using phosphonium based catalysts have been disclosed in “Linear Polyphosphonates that Exhibit an Advantageous Combination of Properties, and Methods Related Thereto”, U.S. Ser. No. 10/374,155 and PCT/US04/05337 and “Branched Polyphosphonates that Exhibit an Advantageous Combination of Properties, and Methods Related Thereto”, U.S. Ser. No. 10/374,829 and PCT/US04/05337, the contents of each of these patent applications incorporated herein by reference in their entirety. An added phosphonium catalyst of from about 4×10⁻⁵ to about 1.2×10⁻³ mole that is present in the transesterification melt can be removed during heating of the melt.

Prior linear and branched polyphosphonates produced by a melt transesterification reaction use catalysts which add to the cost of the polyphosphonate and can cause unwanted side reactions even if they are neutralized or removed from the melt after a period of time. Where the catalysts remains in the final polymer product, it may cause problems such as increased haze, reduced hydrolytic stability, reduced optical transparency, increased color and can catalyze the thermal degradation of the polymer during use at elevated temperature. To reduce material and processing costs and provide polyphosphonates that exhibit a good combination of properties such as good toughness, low haze, low color, good transparency, good hydrolytic stability and acceptable melt processability, there is a need for polyphosphonates with reduced added catalyst or that are free of added catalyst and methods to prepare such polyphosphonates from a melt transesterification process.

### SUMMARY

Embodiments of the invention include methods for making polyphosphonates by a melt transesterification process that includes the presence of a stoichiometric excess of either a bisphenol or a phosphonic acid diaryl ester and absent sufficient catalyst or absent catalyst. Embodiments of the invention also include compositions of polyphosphonates prepared by a transesterification process in a melt that includes the presence of a stoichiometric excess of either a bisphenol or a phosphonic acid diaryl ester and absent sufficient catalyst or absent catalyst. The polyphosphonates can be linear or branched; branched polyphosphonates can be made by including an optional branching agent. The compositions and articles prepared including them can exhibit an excellent combination of properties such as flame resistance and low color. Compositions including these polyphosphonates, linear or branched, can also be used in flame retardant coatings, fibers, and with other thermoplastic materials.

Other embodiments of the methods for making polyphosphonates by a transesterification process devoid or free of a catalyst and compositions of polyphosphonates prepared by a transesterification process free or devoid of a catalyst include using a molar excess of one or more bisphenols or a molar excess of one or more phosphonic acid diaryl esters in the transesterification reaction. The polyphosphonates can be linear or branched; branched polyphosphonates can be made by including an optional branching agent. The compositions and articles prepared including polyphosphonates can exhibit an excellent combination of properties such as flame resistance and low color. Compositions including these polyphosphonates, which can be linear or branched, can also be used in flame retardant coatings, fibers, and in compositions with other thermoplastic materials.

One embodiment includes acts for producing both linear or branched polyphosphonates via the melt transesterification reaction of a phosphonic acid diaryl ester and a bisphenol without an added catalyst. This method reduces that number of steps in the synthesis process, provides polyphosphonates with a good combination of properties, and reduces the cost for the catalyst.

One embodiment is a process where a mixture, which can include a range of non-stoichiometric ratios of phosphonic acid diaryl ester to bisphenol and is absent sufficient catalyst or absent catalyst, is reacted in a melt process to produce polyphosphonates with a favorable combination of properties. Optionally the mixture includes a branching agent. This approach mitigates or eliminates the need for catalysts. Catalysts are expensive and end up in the final polymer product and may cause detrimental effects in polyphosphonate polymers such as a decrease in the hydrolytic stability, an increase in haze, or a decrease thermal degradation temperature.

One embodiment of a composition includes formulating polymer compositions that include any of these melt processed polyphosphonates or combinations of them that are absent sufficient catalyst or absent catalyst with other polymers such as commodity or engineering plastics. A polymer composition comprises at least one polyphosphonate of the present invention with at least one other polymer, which may be a commodity or engineering plastic, such as polycarbonate, polyacrylate, polyacrylonitrile, polyester, polyamide, polystyrene, polyurethane, polyurea, polyepoxy, poly(acrylonitrile butadiene styrene), polyimide, polyarylate, poly(arylene ether), polyethylene, polypropylene, polyphenylene sulfide, poly(vinyl ester), polyvinyl chloride, bismaleimide polymer, polyanhydride, liquid crystalline polymer, cellulose polymer, or any combination thereof. The polymer composition may be produced via blending, mixing, or compounding the constituent polymers. The melt processed polyphosphonates absent sufficient catalyst or absent catalyst with these polymers can result in polymer compositions that exhibit flame resistance (e.g., high limiting oxygen index, LOI), heat stability (minimal Tg depression), good processing characteristics (e.g., reduced melt viscosity), low color, or a combination of these properties.

One embodiment includes articles of manufacture produced from the present polyphosphonates or from polymer compositions comprising these polyphosphonates. The polyphosphonates and polymer compositions including them can be used as coatings or they can be used to fabricate free-standing films, fibers, foams, molded articles, and fiber reinforced composites.

Embodiments of compositions can include a mixture of one or more phosphonic acid diaryl esters and one or more bisphenols absent sufficient catalyst or absent catalyst for a transesterification reaction in a melt, where either the phosphonic acid diaryl esters or the bisphenols is present in a stoichiometric excess. Optionally a branching agent may be present in the mixture. The stoichiometric excess can range up to about 50 mole percent of either the phosphonic acid diaryl esters or the bisphenols. In some embodiments the stoichiometric excess can be about 2 or 3 percent up to about 15 or 16 percent of either the phosphonic acid diaryl esters or the bisphenols. In some embodiments the stoichiometric excess can be from about 5 mole percent to about 15 mole percent, from about 5 mole percent to about 25 mole percent, or from about 5 to about 50 mole percent of either the phosphonic acid diaryl esters or the bisphenols. In still other embodiments, the mixture can include either the phosphonic acid diaryl esters or the bisphenols in a molar excess in a range from about 25 mole percent up to about 50 mole percent. The mixture of stoichiometrically imbalanced phosphonic acid diaryl ester and bisphenol, and optional branching agent, absent sufficient catalyst or absent catalyst is heated to a melt to form the polyphosphonate and to remove volatile reaction products from the melt. The melt can be heated under a reduced pressure to remove evolved phenol from the heated mixture. The heating of the melt can be continued until the evolution of phenol from the transesterification reaction has produced the desired polyphosphonate or the evolution of phenol has essentially stopped or has stopped. The optional branching agent in the mixture can be present in up to about 10 mole percent in some embodiments; in other embodiments the branching agent can be present up to about 50 mole percent. Where a branching agent is included in the mixture, sufficient bisphenol or phosphonic acid diaryl ester is provided to react, or completely react, with the branching agent while retaining a stoichiometric imbalance of the bisphenol to the phosphonic acid diaryl ester in the mixture.

In some embodiments the bisphenol in the mixture can include one or more of bisphenol A, 1,3-dihydroxybenzene, or 1,4-dihydroxybenzene. In other embodiments, the bisphenol can include 1,3-dihydroxybenzene, 1,4-dihydroxybenzene, or a combination of these. Some embodiments of the composition can further include a structurally hindered antioxidant like structural hindered phenols, structurally hindered phosphites, or other antioxidants including these.

One embodiment of a composition can include a mixture of phosphonic acid diaryl ester and bisphenol absent sufficient catalyst or absent catalyst for a melt transesterification reaction, where either phosphonic acid diaryl ester or bisphenol is present in a molar excess, the mixture heated to a melt to remove volatile reaction products and to produce a polyphosphonate having a relative viscosity of greater than about 1.03 when measured on a 0.5 percent solution in methylene chloride at 23° C. The mixture for making the polyphosphonate can further include a branching agent in the mixture. In some embodiments the branching agent in the mixture can be present in excess of up to about 10 mole percent relative to the bisphenol; in other embodiments the branching agent can be present in excess of up to about 50 mole percent relative to the bisphenol; sufficient bisphenol or phosphonic acid diaryl ester is provided to react, or completely react, with the branching agent while retaining a stoichiometric imbalance of bisphenol to phosphonic acid diaryl ester in the mixture. In some embodiments the bisphenol in the mixture can include one or more of bisphenol A, 1,3-dihydroxybenzene, or 1,4-dihydroxybenzene. Some embodiments of the composition can further include a structurally hindered antioxidant like structural hindered phenols, structurally hindered phosphites, or a combination of these.

Advantageously, by using an excess of bisphenol or phosphonic acid diaryl ester, present embodiments of polyphosphonates can be made by a melt transesterification process while mitigating or without the addition of expensive catalysts. Such polyphosphonates exhibit one or more properties such as good toughness, low haze, low color, good transparency, good hydrolytic stability, or acceptable melt processability. Present embodiments of these polyphosphonates can be made without removal of added solvents, can be made without a precipitation step, and are free of halide containing reagents or evolved halide containing reactants. Present embodiments of these polyphosphonates can be made without sublimation of catalyst, or neutralization and distillation of volatile catalyst neutralization products, to remove part or all of the catalyst from these polyphosphonates thereby eliminating the cost of the catalyst and the added steps for catalyst removal.

These and other feature, aspects, and advantages of the present invention will become better understood with regard to the following description, appended claims, and accompanying drawings.

### DESCRIPTION

Before the present compositions and methods are described, it is to be understood that they are not limited to the particular compositions, methodologies or protocols described, as these may vary. It is also to be understood that the terminology used in the description is for the purpose of describing the particular versions or embodiments only, and is not intended to limit their scope which will be limited only by the appended claims.

It must also be noted that as used herein and in the appended claims, the singular forms “a”, “an”, and “the” include plural reference unless the context clearly dictates otherwise. Thus, for example, reference to a “bisphenols” is a reference to one or more bisphenols and equivalents thereof known to those skilled in the art, and so forth. Unless defined otherwise, all technical and scientific terms used herein have the same meanings as commonly understood by one of ordinary skill in the art. Although any methods and materials similar or equivalent to those described herein can be used in the practice or testing of embodiments disclosed, the preferred methods, devices, and materials are now described. All publications mentioned herein are incorporated by reference. Nothing herein is to be construed as an admission that the present disclosure is not entitled to antedate these references.

“Optional” or “optionally” means that the subsequently described event or circumstance may or may not occur, and that the description includes instances where the event occurs and instances where it does not.

Absent catalyst refers to the melt transesterification synthesis of a branched or linear polyphosphonate where one of the reactants is in stoichiometric excess, for example from about 20 to about 25 mole percent excess (or other excess)of bisphenol or phosphonic acid diaryl ester, and that throughout the reaction, the reaction occurred in the absence or was free of any added catalyst. Absent sufficient catalyst refers to the melt transesterification synthesis of a branched or linear polyphosphonate where one of the reactants is in stoichiometric excess, for example greater than about 20 to about 25 mole percent excess (or other excess) of bisphenol or phosphonic acid diaryl ester, and that throughout the reaction, less than about 4×10⁻⁵ moles, in some embodiments less than 1×10⁻⁵ moles, and in other embodiments less than 1×10⁻⁷ moles, of catalyst per mole of aromatic dihydroxy compound was present in the melt transesterification reaction mixture. In some embodiments, absent sufficient catalyst or absent catalyst refer to a melt transesterification reaction to form a polyphosphonate where phosphonic acid diaryl esters that have purities of less than 98% are used.

The present invention pertains to a method for preparing flame retardant, polyphosphonates via a transesterification process without the use of a catalyst. The resultant polyphosphonates exhibit an advantageous combination of properties (processability, low color and low haze). The polyphosphonates are synthesized by a transesterification reaction that involves reacting a phosphonic acid diaryl ester and a bisphenol, where one is in a molar excess, absent catalyst or absent sufficient catalyst. Branched polyphosphonates may be synthesized by an analogous manner except that a branching agent is added. The terms “flame retardant”, “flame resistant”, “fire resistant” or “fire resistance”, as used herein, mean that the polymer exhibits a LOI of at least 27.

The transesterification reaction absent sufficient catalyst or absent catalyst is conducted at a high temperature in the melt and can be under vacuum, reduced pressure, or other condition to remove volatile reaction by products. The reaction temperature and pressure can be adjusted at several stages during the course of the reaction. Without limitation, the molar ratio of phosphonic acid diaryl ester to bisphenol present in a reaction mixture, absent sufficient transesterification catalyst or absent catalyst during a melt transesterification reaction, can be chosen to result in a linear polyphosphonate or branched polyphosphonate that can have a relative viscosity of about 1.03 to about 1.07, a relative viscosity of about 1.03 or greater, and in some embodiments a relative viscosity of 1.07 or greater, when measured on a 0.5 percent solution of the polymer in methylene chloride at 23° C. Depending upon the bisphenol used, the resulting polyphosphonate in some embodiments can exhibits a Tg of at least about 60° C. or higher, in other embodiments the resulting polyphosphonate can exhibit a Tg of at least about 100° C. or higher as measured by differential scanning calorimetry. In some embodiments, a stoichiometric excess of either phosphonic acid diaryl ester or bisphenol can be used to form the polyphosphonate in a melt transesterification process that is absent sufficient catalyst or absent catalyst. In some embodiments, a stoichiometric imbalance ratio of about 5 mole % up to about 25 mole % excess of either phosphonic acid diaryl ester or bisphenol can be used to form the polyphosphonate in a melt transesterification process that is absent sufficient catalyst or absent catalyst. In some embodiments, a stoichiometric imbalance ratio of 5 mole % up to about 50 mole % excess of either phosphonic acid diaryl ester or bisphenol can be used to form the polyphosphonate in a melt transesterification process that is absent sufficient catalyst or absent catalyst. In some embodiments, a stoichiometric imbalance ratio of 25 mole % up to about 50 mole % excess of either phosphonic acid diaryl ester or bisphenol can be used to form the polyphosphonate in a melt transesterification process that is absent sufficient catalyst or absent catalyst. In some embodiments, a stoichiometric imbalance ratio of up to about 10 mole % excess of phosphonic acid diaryl ester, or up to about 15 mole % excess of the phosphonic acid diaryl ester can be used. It is surprising and non obvious that the reaction can be initiated and proceeds without a catalyst and that such a large molar excess of phosphonic acid diaryl ester or bisphenol can lead to polyphosphonates with a desirable combination of properties.

In the cases where one or more branching agents are used to make branched polyphosphonates, the branching agent contains more than two functional groups that can be hydroxyl or phosphorus ester. Examples include 1,1,1-tris(4-hydroxyphenyl)ethane, trisphenyl phosphate, oligomeric isopropenyl phenol and others. A preferred branching agent is 1,1,1-tris(4-hydroxyphenyl)ethane (a product of DuPont, Wilmington, Del., commercially available from Electronic Polymers, Dallas, Tex.). In a melt transesterification process, the amount of branching agent used to form a branched polyphosphonate absent sufficient transesterification catalyst or absent transesterification catalyst can be chosen to provide a branched polyphosphonate characterized by exhibiting glass transition temperature, T_{g}, of 60° C. or greater, a T_{g} of 100° C. or greater in some embodiments of branched polyphosphonates, or a T_{g} of 107° C. or greater in other embodiments of branched polyphosphonates. In some embodiments, the molar amount of branching agent used (relative to one mole of bisphenol) can be from about 0.001 moles to about 0.03 moles. In some embodiments, the molar amount of branching agent used (relative to one mole of bisphenol) can be from about 0.001 moles to about 0.02 moles. In other embodiments where a branching agent is included in the mixture, the molar amount of branching agent added (relative to one mole of bisphenol) to form a branched polyphosphonate can be from about 0.001 moles to about 0.5 moles (about 0.1 mole percent to about 50 mole percent). In embodiments of present methods or compositions where a branching agent is included in the mixture, sufficient bisphenol or phosphonic acid diaryl ester is provided to react, or completely react, with the branching agent while retaining a stoichiometric imbalance of the bisphenol to the phosphonic acid diaryl ester in the mixture.

The methods of the present invention allow for the use of phosphonic acid diaryl esters having purities less than 98%. The ability to use lower purity monomer is another major advantage because it mitigates the need for additional purification steps, which contributes to cost reduction. By following the method of the present invention, polyphosphonates with outstanding flame resistance, improved heat stability, improved toughness, improved processability and lower color and haze can be obtained. In addition, a second heating step after the reaction can be used to impart improved hydrolytic stability to the polyphosphonates and can result in clear, haze-free polyphosphonates.

The term “improved heat stability”, as used herein, refers to an increase in the glass transition temperature of the polyphosphonates of the present invention as compared to state-of-the-art branched polyphosphonates. For example, the state-of-the-art branched polyphosphonate based on bisphenol A described in U.S. Pat. No. 4,331,164, (column 10) and in Die Angewandte Makromolekulare Chemie [(Vol. 132, 8 (1985)] has a T_{g} of 90° C., whereas the branched polyphosphonates based on bisphenol A in embodiments of present compositions exhibit a T_{g} of 100° C. or greater in some embodiments. Both samples have similar relative solution viscosities. This significant increase in T_{g} implies a better retention of properties at elevated temperatures and a higher potential use temperature.

The methods of synthesizing polyphosphonates, which can be branched or linear polyphosphonates, and compositions from them can use a combination where either phosphonic acid diaryl ester or bisphenol is in stoichiometric excess, optionally a branching agent, and absent sufficient catalyst or absent catalyst. A method for producing polyphosphonates that can be referred to as copolyphosphonates may include the use of an excess of more than one bisphenol and/or more than one phosphonic acid diaryl ester, and optionally a branching agent, in a melt transesterification reaction that is absent sufficient catalyst or absent catalyst. The methods for synthesizing can produce polyphosphonates with a relative viscosity of about 1.03 to about 1.07, 1.03 or greater, or 1.07 or greater when measured on a 0.5 percent solution in methylene chloride at 23° C. In the melt transesterification process used to form these branched or linear polyphosphonate, absent sufficient transesterification catalyst or absent transesterification catalyst, the polyphosphonate can be characterized by exhibiting a T_{g}, of 60° C. or greater, a T_{g} of 100° C. or greater in some embodiments of polyphosphonates, or a T_{g} of 107° C. or greater in other embodiments of polyphosphonates.

One embodiment of a method for producing polyphosphonates consists of placing phosphonic acid diaryl ester and bisphenol into a reaction vessel where the phosphonic acid diaryl ester is in molar excess; and optionally adding a branching agent in the vessel. The mixture in the vessel can be heated under vacuum or reduced pressure to a temperature where phenol begins to distill from the vessel; the heating and removal of phenol from the reaction mixture can continue until the evolution of phenol has stopped. An additional heating step can be performed after the polycondensation reaction. The initial molar excess of phosphonic acid diaryl ester in the mixture can range from about 5 to about 25 mole % , in some embodiments it can be up to about 10 mole %, in other embodiments the initial molar excess of phosphonic acid diaryl ester can be up to about 5 mole %. Where branched polyphosphonates are made, the optional branching agent can be 1,1,1-tris(4-hydroxyphenyl)ethane.

Some embodiments for making polyphosphonates, which can be branched or linear polyphosphonates, and compositions from them can include using a phosphonic acid diaryl ester which can be represented by the following chemical structure wherein R can be a

lower alkyl aliphatic hydrocarbon of C₁-C₄, cycloaliphatic, or aromatic. One or more of these phosphonic diaryl esters may be used to make the polyphosphonates.

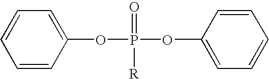

Some embodiments for making polyphosphonates, which can be branched or linear polyphosphonates, and compositions from them, can include a phosphonic acid diaryl ester that includes methyldiphenoxyphosphine oxide.

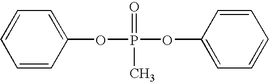

Embodiments of the present synthetic method can be used with any bisphenol that forms polyphosphonate. Bisphenols for use herein can include 4,4′-dihydroxybiphenyl, 4,4′-dihydroxyphenyl sulfone, 2,2-bis(4-hydroxyphenyl) propane (bisphenol A) (these bisphenols are commercially available from, for example, Sigma-Aldrich Co., Milwaukee, Wis.; Biddle Sawyer Corp., New York, N.Y.; and Reichold Chemicals, Inc., Research Triangle Park, N.C., respectively), 4,4′-dihydroxyphenyl ether, 9,9-dihydroxy-phenylfluorene, 1,1 -bis(4-hydroxyphenyl)-3,3-dimethyl-5-methyl cyclohexane (TMC) (chemical structure shown below), 1,4-dihydroxybenzene, 1,3-dihydroxybenzene (resorcinol), 1,3-dihydroxynaphthalene, and

combinations of these. Copolymers prepared using two or more of any combination of bisphenols can also be prepared via this synthetic method.

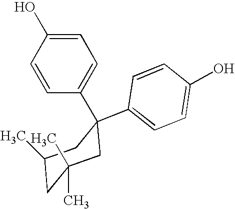

The polyphosphonates of the present invention can also be used to produce polymer compositions having advantageous characteristics. The term “polymer composition”, as used herein, refers to a composition that comprises at least one polyphosphonate of the present invention and at least one other polymer. There term “other polymer”, as used herein, refers to any polymer other than the polyphosphonates of the present invention. These other polymers may be commodity, engineering plastics, or thermoplastics. Examples of these other polymers include polycarbonate, polyacrylate, polyacrylonitrile, polyester, polyamide, polystyrene (including high impact strength polystyrene), polyurethane, polyurea, polyepoxy, poly(acrylonitrile butadiene styrene), polyimide, polyarylate, poly(arylene ether), polyethylene, polypropylene, polyphenylene sulfide, poly(vinyl ester), polyvinyl chloride, bismaleimide polymer, polyanhydride, liquid crystalline polymer, cellulose polymer, or any combination thereof (commercially available from, for example, GE Plastics, Pittsfield, Mass.; Rohm & Haas Co., Philadelphia, Pa.; Bayer Corp.—Polymers, Akron, Ohio; Reichold; DuPont; Huntsman LLC, West Deptford, N.J.; BASF Corp., Mount Olive, N.J.; Dow Chemical Co., Midland, Mich.; GE Plastics; DuPont; Bayer; Dupont; ExxonMobil Chemical Corp., Houston, Tex.; ExxonMobil.; Mobay Chemical Corp., Kansas City, Kans.; Goodyear Chemical, Akron, Ohio; BASF Corp.; 3M Corp., St. Paul, Minn.; Solutia, Inc., St. Louis, Mo.; DuPont; and Eastman Chemical Co., Kingsport, Tenn., respectively). The polymer compositions may be produced via blending, mixing, or compounding the constituent polymers. The polyphosphonates of the present invention impart unexpectedly high flame retardant properties and significantly better processability to the resulting polymer compositions, with a negligible effect on their heat stability, toughness, and color.

It is contemplated that polyphosphonates or the polymer compositions of the present invention may comprise other components, such as fillers, surfactants, organic binders, polymeric binders, crosslinking agents, coupling agents, anti-dripping agents, colorants, inks, dyes, or any combination thereof. In some embodiments of the present compositions absent catalyst or absent sufficient catalyst, and which can include branched polyphosphonates, linear polyphosphonates, or combinations of these, one or more antioxidants can be added to the composition. Antioxidants that can be added to these compositions can include but are not limited to sterically hindered phenols or sterically hindered phosphites.

The polyphosphonates and the polymer compositions of the present invention can be used as coatings or they can be used to fabricate articles, such as free-standing films, fibers, foams, molded articles and fiber reinforced composites. These articles may be well-suited for applications requiring fire resistance.

The polyphosphonates produced via the synthetic method of the present invention are self-extinguishing in that they immediately stop burning when removed from a flame. Any drops produced by melting these polyphosphonates in a flame instantly stop burning and do not propagate fire to any surrounding materials. Moreover, these polyphosphonates do not evolve any noticeable smoke when a flame is applied. The LOI of a material is indicative of its ability to burn once ignited. The test for LOI is performed according to a procedure set forth by the American Society for Test Methods (ASTM). The test, ASTM D2863, provides quantitative information about a material's ability to burn or “ease of burn”. If a polymeric material has an LOI of at least 27, it will, generally, burn only under very high applied heat.

Methods to synthesize polyphosphonates from the melt transesterification reaction of phosphonic acid diaryl ester and bisphenol without the need for a metal catalyst is disclosed. Consequently, the resulting polyphosphonates exhibit outstanding flame resistance and a more advantageous combination of heat stability (e.g., T_{g}), toughness, processability, hydrolytic stability and low haze as compared to the state-of-the-art polyphosphonates prepared using a metal catalyst. Such improvements make these materials useful in applications in the automotive and electronic sectors that require outstanding fire retardancy, high temperature performance, and low haze. Methods for synthesizing these polyphosphonates can use no catalyst and requires less pure starting materials than other methods, which thereby reduces production costs.

Having generally described the invention, a more complete understanding thereof may be obtained by reference to the following examples that are provided for purposes of illustration only and do not limit the invention.

### EXAMPLE 1

State-of-the-Art Comparative Example (Branched Polyphosphonate)

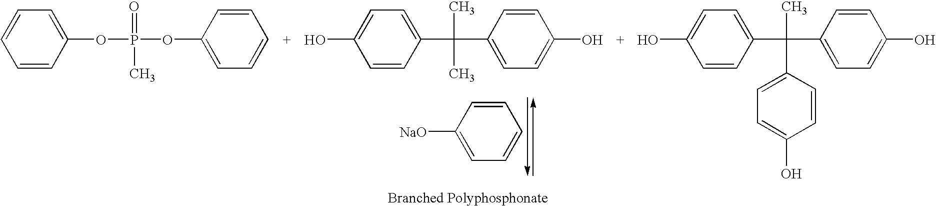

A branched polyphosphonate was prepared following information contained in U.S. Pat. Nos. 4,331,614 and 4,415,719 for comparison with the branched polyphosphonates of the present invention. The molar excess of 2,2-bis(4-hydroxyphenyl)propane (bisphenol A), (33.28 g, 0.1457 moles) to the phosphonic diester (37.07 g, 0.1493 mole) was 2.4 mole %. The amount of sodium phenolate used (0.006 g, 5.16 ×10⁻⁵ moles) was 3.54 ×10⁻⁴ moles relative to one mole of bisphenol, and (0.459 g, 1.5 ×10⁻³ moles) of 1,1,1-tris(4-hydroxyphenyl)ethane (i.e., branching agent) was used. The polymer was isolated and it exhibited some toughness, but not as tough as the polymers described in Example 2. A 0.5% solution of the polymer in methylene chloride exhibited a relative viscosity of about 1.09 at 23° C. A film was cast from methylene chloride solution, it exhibited a T_{g} of about 90.6° C., lower toughness and more yellow color than similar films prepared from the polymers prepared in accordance to the methods described in Example 2.

### EXAMPLE 2

Synthesis of a Branched Polyphosphonate without using a Catalyst

A branched polyphosphonates according to the invention was prepared from methyldiphenoxyphosphine oxide (95.6% purity, 46.23 g), 2,2-bis(4-hydroxyphenyl)propane (bisphenol A) (33.28 g) and 1,1,1-tris(4-hydroxyphenyl)ethane (0.459 g). This corresponds to a molar excess of 20% of methyldiphenoxyphosphine oxide to bisphenol A. The reaction was conducted according to the conditions below.

1. The chemicals are charged into the reactor.

2. The temperature controller of the oil bath is turned on to heat the oil baths to 250° C. and the temperature controller for the distilling column (Hempel-type, vacuum jacketed, 24 cm in length with a center section of 10 cm in length packed with glass beads) was turned on to heat the columns to 130° C.

3. Ice was placed into the collector trap and liquid nitrogen was placed into the second trap.

4. When the oil temperature reached 250° C., the vacuum regulator was adjusted to 200 mm Hg, the vacuum pump was turned on and the vacuum valve was opened.

5. The reactions were conducted according to the parameters in Table 1.

6. The oil bath was removed, the vacuum valve closed and the vacuum pump turned off.

7. The reaction mixture was allowed to cool for 16 hours.

8. The vacuum valve was opened.

Post-reaction:

9. The 75° angle distillation adapter was re-installed directly to the right neck of the 250 ml flask of the first reaction step and connected to a new two-neck 100 ml flask that served as a collector/trap. After optionally adding new catalyst

10. The vacuum regulator was set to 0 (full vacuum) and the vacuum pump turned on, and the vacuum valve was opened.

11. Heating tape was applied from the right neck of the 250 ml flask to the top angle of the distillation adapter.

12. The temperature controller of the oil bath was set to 305° C.

13. The temperature controller for the tape wrapping the distillation adapter was set to 150° C.

14. The reaction was heated at 305° C. for 5-6 hours.

15. After heating for 1 hour, the temperature controller for the tape wrapping the distillation adapter was set to 180° C.

TABLE 1
Reaction Parameters for Example 2

| Time | Oil Bath Temp. | Distillation column | Vacuum | |
|---|---|---|---|---|
| (min) | (° C.) | Temp. (° C.) | (mm Hg) | Comment |
| — | 250 | 130 | | Start heating |
| 0 | 250 | 130 | 200 | Start vacuum |
| 30 | 250 | 130 | 150 | |
| 55 | 250 | 130 | 100 | |
| 125 | 250 | 100 | 80 | |
| 135 | 250 | 100 | 50 | |
| 170 | 250 | 100 | 20 | |
| 200 | 250 | 100 | 10 | |
| 210 | 250 | 100 | <0.3 | Full vacuum |
| 225 | 270 | 100 | <0.3 | |
| 270 | 305 | 100 | <0.3 | |
| 290 | 305 | 130 | <0.3 | |
| 295 | 305 | 150 | <0.3 | |
| 315 | 305 | 180 | <0.3 | |
| 360 | 305 | 180 | <0.3 | Turn off the |
| | | | | heat |

After the reaction was complete the polymer was isolated and characterized. It exhibited a T_{g} of 102° C. A 0.5% solution of the polymer in methylene chloride exhibited a relative viscosity of about 1.23 at 23° C. Gel permeation chromatography indicated a number average molecular weight of 6524 g/mole and a weight average molecular weight of 16719 g/mole. The polymer dispersity was 2.56.

As noted herein, the present invention is applicable to polyphosphonates synthesized via a transesterification process and methods and applications related thereto. The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification.

Although the disclosure has provided considerable detail with reference to certain preferred embodiments thereof, other versions are possible. Therefore the spirit and scope of the appended claims should not be limited to the description and the preferred versions contain within this specification.

What is claimed is:

1. A composition comprising:
a phosphonic acid diaryl ester and a bisphenol in a melt absent sufficient catalyst for a melt transesterification reaction, where either phosphonic acid diaryl ester or bisphenol in the melt is present in stoichiometric excess, the melt heated to evolve a phenol and form a polyphosphonate absent sufficient catalyst.

2. The composition of claim 1 where the where either phosphonic acid diaryl ester or bisphenol is present in excess of from about 5 mole percent to about 15 mole percent.

3. The composition of claim 1 where the where either phosphonic acid diaryl ester or bisphenol is present in excess of up to about 50 mole percent.

4. The composition of claim 1 where the branching agent in the mixture is present in an amount of up to 50 mole percent and sufficient bisphenol or phosphonic acid diaryl ester provided to react with the branching agent.

5. The composition of claim 1 where the bisphenol in the mixture can comprise one or more of bisphenol A, 1,3-dihydroxybenzene, or 1,4-dihydroxybenzene.

6. The composition of claim 1 further comprising an antioxidant.

7. The composition of claim 1 further comprising at least one other polymer.

8. A composition comprising:
a phosphonic acid diaryl ester and a bisphenol in a mixture absent sufficient catalyst for a melt transesterification reaction, where either phosphonic acid diaryl ester or bisphenol is present in a stoichiometric excess, the mixture heated to a melt to remove volatile reaction products and to produce a polyphosphonate absent sufficient catalyst with a relative viscosity of greater than about 1.03 when measured on a 0.5 percent solution in methylene chloride.

9. The composition of claim 8 where either phosphonic acid diaryl ester or bisphenol is present in excess of from about 5 mole percent to about 15 mole percent.

10. The composition of claim 8 where either phosphonic acid diaryl ester or bisphenol is present in excess of up to about 50 mole percent.

11. The composition of claim 8 further including a branching agent in the mixture, the branching agent present in an amount of up to about 50 mole percent and sufficient bisphenol or phosphonic acid diaryl ester provided to react with the branching agent.

12. The composition of claim 8 where the bisphenol in the mixture comprises one or more of bisphenol A, 1,3-dihydroxybenzene, or 1,4-dihydroxybenzene.

13. The composition of claim 8 further comprising an antioxidant.

14. The composition of claim 8 further comprising at least one other polymer.

15. A method comprising:
forming a mixture of phosphonic diaryl ester and bisphenol, the mixture free of added catalyst for a melt transesterification reaction, and where either phosphonic acid diaryl ester or bisphenol in the mixture is present in stoichiometric excess in the mixture; and
heating the mixture to form a melt and removing evolved phenol from the heated mixture to form a polyphosphonate free of added catalyst.

16. The method of claim 15 where the where either phosphonic acid diaryl ester or bisphenol is present in excess of up to about 25 mole percent.

17. The method of claim 15 further including a branching agent in the mixture, the branching agent present in an amount of up to about 10 mole percent and sufficient bisphenol or phosphonic acid diaryl ester provided to react with the branching agent.

18. The method of claim 15 where the bisphenol in the mixture can comprise one or more of bisphenol A, 1,3-dihydroxybenzene, or 1,4-dihydroxybenzene.

19. The method of claim 15 where the mixture further comprises an antioxidant.

20. The method of claim 15 further comprising the act of producing a polymer composition of the catalyst free polyphosphonate with at least one other polymer.
